(19) United States
(12) Patent Application Publication
(10) Pub. No.: US 2009/0257774 A1
(43) Pub. Date: Oct. 15, 2009

(54) Methods for increasing printer cartridge compatibility

(75) Inventors: Craig Rummler, Northridge, CA (US); Gary Silva, Reseda, CA (US)

Correspondence Address: Future Graphics Imaging Corporation, 1175 Aviation Place, San Fernando, CA, 91340, US

(73) Assignee: Future Graphics Imaging Corporation, San Fernando, CA (US)

(21) Appl. No.: 12/386,099

(22) Filed: Apr. 13, 2009

Related U.S. Application Data
(60) Provisional application No. 61/123,992, filed on Apr. 11, 2008.

(51) Int. Cl. G03G 15/00

(52) U.S. Cl. 399/109

(57) ABSTRACT

A method of making an aftermarket printer cartridge, the aftermarket printer cartridge substantially resembling an original market printer cartridge, the original market printer cartridge comprising a key set attached to a toner hopper, the key set comprising an arched structure and at least one elongated structure attached to the arched structure, the method comprising providing an aftermarket toner hopper resembling the toner hopper of the original market printer cartridge, the aftermarket toner hopper missing at least one elongated structure of the key set.

### CROSS REFERENCES TO RELATED APPLICATIONS

This application is related to and claims the benefit of priority from U.S. provisional patent application Ser. No. 61/123,992, filed Apr. 11, 2008, the entire contents of which are incorporated herein.

### FIELD OF INVENTION

The present invention relates to electrophotography, particularly methods for increasing printer cartridge compatibility.

### BACKGROUND

Remanufacturers of printer cartridges need certain printer cartridges more than other printer cartridges. Empties for printer cartridges that are in demand may be difficult or costly to gather. If remanufacturers have a way to convert less popular cartridges to popular cartridges, then their remanufacturing costs may be lowered and profit margins may be increased. Certain businesses in the aftermarket printer cartridge chain may also desire for conversion methods that make cartridges into universal or compliant cartridges. For instance, manufacturers of printer cartridge plastics may benefit from conversion methods, as the number of molds they may have to use may be reduced. Distributors of printer cartridge plastics may desire universal printer cartridges so that they can have reduced number products types in their inventories. If there is a way to convert a printer cartridge so that it can work with substantial amount of printers, distributors may only need to carry a minimal number of printer cartridge plastic type in their inventory. Printer cartridge conversion methods that increase the compatibility of certain printer cartridges are desired and are addressed by the present invention.

### BRIEF DESCRIPTION OF THE PREFERRED EMBODIMENTS OF THE PRESENT INVENTION

A method of making an aftermarket printer cartridge, the aftermarket printer cartridge substantially resembling an original market printer cartridge, the original market printer cartridge comprising a key set attached to a toner hopper, the key set comprising an arched structure and at least one elongated structure attached to the arched structure, the method comprising providing an aftermarket toner hopper resembling the toner hopper of the original market printer cartridge, the aftermarket toner hopper missing at least one elongated structure of the key set.

An aftermarket printer cartridge configured to be used with an original market printer, the original market printer comprising a plurality of printer cartridge housing for housing a plurality of printer cartridges, each printer cartridge housing comprising a distinct cartridge screening wall, each distinct cartridge screening wall defining a distinct set of recesses for receiving various structures of a printer cartridge key set, the aftermarket printer cartridge comprising a toner hopper resembling an original market toner hopper; a first printer cartridge key set attached to one end of the toner hopper, the first printer cartridge key set comprising a first arched structure; and a second printer cartridge key set attached to the same end of the toner hopper, the second printer cartridge key set being positioned proximate to the first printer cartridge key set, the second printer cartridge key set comprising a second arched structure, wherein the first and second arched structures of the toner hopper are configured to insert through their respective recesses on the cartridge screening wall, the toner hopper being usable with multiple printer cartridge housings having distinct cartridge screening walls.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways.

### BRIEF DESCRIPTION OF THE DRAWINGS

FIG. 1 is substantially a perspective view of an original market colored printer cartridge.

FIG. 2 is substantially a right side view of the colored printer cartridge of FIG. 1.

FIG. 3 is substantially a schematic view of the colored printer cartridge of FIG. 1 being positioned next to its respective housing within the printer.

FIG. 4a is substantially side view of an original market colored printer cartridge of a first brand.

FIG. 4b is substantially side view of an original market colored printer cartridge of a second brand.

FIG. 5 is substantially an embodiment of a printer cartridge conversion method of the present invention.

FIG. 6 is substantially another embodiment of a printer cartridge conversion method of the present invention.

FIG. 7 is substantially yet another embodiment of a printer cartridge conversion method of the present invention.

FIG. 8a is a substantially a side view of a printer cartridge converted using at least one of the methods of the present invention.

FIG. 8b is a substantially a side view of a toner hopper created using at least one of the methods of the present invention.

FIG. 8c is a substantially a side view of yet another printer cartridge converted using at least one of the methods of the present invention.

FIG. 9a is substantially a side view of an original market cartridge intended for using black toner.

FIG. 9b is substantially a side view of an original market cartridge intended for using cyan toner.

FIG. 9c is substantially a side view of an original market cartridge intended for using magenta toner.

FIG. 9d is substantially a side view of an original market cartridge intended for using yellow toner.

FIG. 10 is substantially an embodiment of a printer cartridge conversion method of the present invention.

FIG. 11 is substantially another embodiment of a printer cartridge conversion method of the present invention.

FIG. 12 is substantially yet another embodiment of a printer cartridge conversion method of the present invention.

FIG. 13 is substantially a side view of a printer cartridge converted using at least one of the methods of the present invention.

FIG. 14 is substantially a side view of another printer cartridge converted using at least one of the methods of the present invention.

FIG. 15 is substantially an embodiment of a printer cartridge conversion method of the present invention.

FIG. 16 is substantially a side view of a printer cartridge converted using at least one of the methods of the present invention.

FIG. 17 is substantially another embodiment of a printer cartridge conversion method of the present invention.

FIG. 18 is substantially a side view of a printer cartridge converted using at least one of the methods of the present invention.

### DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. Also, it is to be understood that the phraseology and terminology employed herein are for the purpose of description and should not be regarded as limiting.

The present invention includes various methods of converting a printer cartridge that is initially designed for use with a particular printer to a printer cartridge that may be used with a different printer or various other printers. The present invention further includes various methods for converting a printer cartridge initially designed by original market manufacturers to be filled with a specific color of toner to a printer cartridge that is not color specific and may effectively be filled with a choice of either black, magenta, cyan, or yellow toners. As used herein, the term “colored printer cartridges” refers to printer cartridges configured for use with printers that produce colored prints and which typically use black, magenta, cyan, or yellow toners.

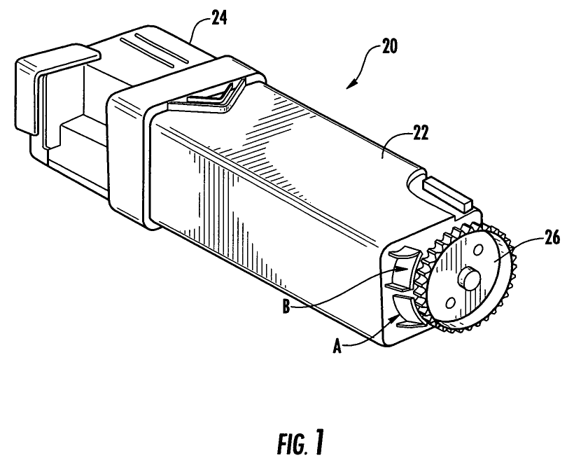

Referring now to FIG. 1, original market colored printer cartridges, such as colored printer cartridge 20, may include a toner hopper 22 where colored toner may be stored. Each colored printer cartridge 20 may contain toner of a single color, which may be black, cyan, magenta, or yellow. The toner hopper 22 may be attached to a waste hopper 24. The waste hopper 24 is typically where toner in excess of toner used for each print job is stored. Opposite the waste hopper 24 and attached to the toner hopper 22 is an agitator drive gear 26. The agitator drive gear 26 is configured to operate with a gear from the printer (not shown) to rotate the agitator inside the toner hopper 22 (not shown) and controllably push the toner towards a toner exit port (not shown) of the toner hopper 22 thereby providing the printer with toner.

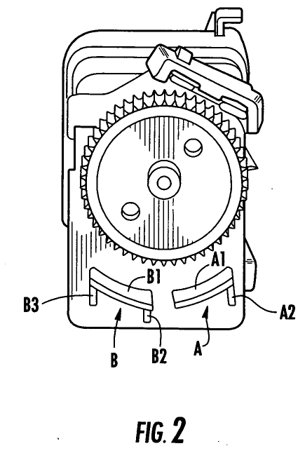

The colored printer cartridge 20 may also include a plurality of key sets (hereinafter “key set A” and “key set B,” respectively) positioned below the agitator drive gear 26. Referring now to FIG. 2, key set “A” may include an arched structure “A1” and elongated structure “A2” attached to the arched structure “A1.” Elongated structure “A2” may be attached to the arched structure “A1.” Key set “A” may be positioned substantially adjacent to the key set “B.” Key set “B” may include an arched structure “B1” and a plurality of elongated structures attached to the arched structure “B1”—namely, elongated structure “B2” and elongated structure “B3.”

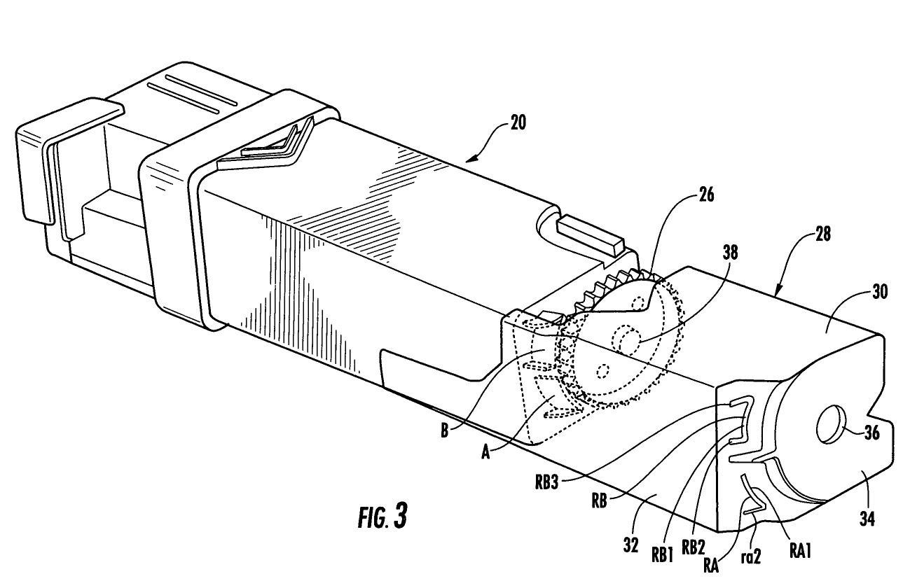

Referring now to FIG. 3, the printer cartridge 20 may be inserted into a printer cartridge housing 28 within the printer. The housing 28 may at least partially enclose, support, and position the printer cartridge 20 so that the printer cartridge can be properly positioned to dispense toner, and the printer may rotate the agitator drive gear 26. The printer cartridge housing 28 may include a plurality of walls 30, 32, and 34. Wall 34 may define a drive gear protrusion receiving recess 36 configured to receive drive gear protrusion 38 located substantially in the center of the agitator drive gear 26.

Wall 34 may further define a plurality of key receiver sets “RA” and “RB.” Key receiver set “RA” may include an arched recess “RA1” configured to receive arched structure “A1” and a tab receiving recess “RA2” configured to receive elongated structure “A2.” Key receiver set “RB” includes an arched recess “RB1” configured to receive arched structure “B1,” tab receiving recess “RB2” configured to receive elongated structure “B2,” and tab receiving recess “RB3” configured to receive elongated structure “B3.” It can be realized that by virtue of the recesses wall 34 defines, wall 34 may function as a cartridge screening wall in that it ensures that the correct cartridge is inserted into the housing 28. If the cartridge has key sets that are not properly received by the recesses of the wall 34, the cartridge may not work with the printer.

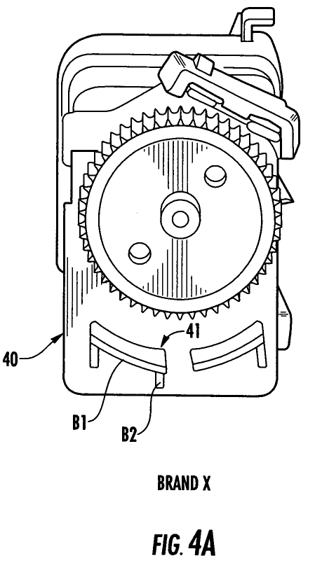

The applicants have discovered that key sets “A” and “B” may each have their respective cartridge identification functions. Specifically, the applicants have discovered that original market printer cartridges with different original market brand names may have different key set “B” configurations. For instance, with reference to FIG. 4a, original market printer cartridge with brand name “X” 40 may have an elongated structure “B2” positioned at the tip 41 of the arched structure “B1.” In contrast, original market printer cartridge with brand name “Y” 42 (FIG. 4b) may have an elongated structure “B2” substantially in between the center and the tip 41 of arched structure “B1.” Based on this discovery, applicants have devised various methods for increasing printer compatibility of printer cartridges.

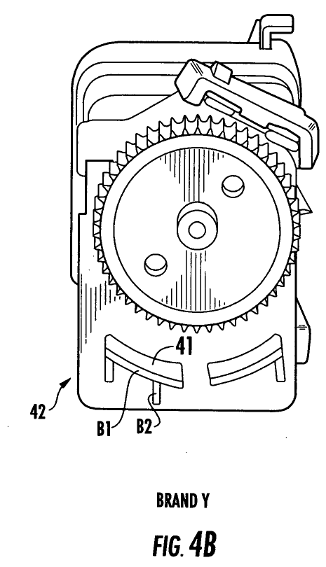

Referring now to FIG. 5, a first embodiment of a conversion method 44 of the present invention includes the following steps. At step 46, a used original market printer cartridge of a particular original market brand name is preferably provided. At step 48, at least the elongated structure “B2” is preferably detached from the printer cartridge. The elongate structure “B2” may be detached from the printer cartridge using methods known in the art, such as cutting, breaking, destroying, or ruining the elongated structure B2. Conventional tools known in the art may be used to detach the elongated structure B2, such as a utility knife or a rotary cutting tool. Next, the printer cartridge may now be used with an original market printer of a different brand (step 50). It can now be realized that certain methods of the present invention may broaden the use of printer cartridges by removing the original market brand restrictions provided by certain key sets components of printer cartridges, such as elongated structure B2.

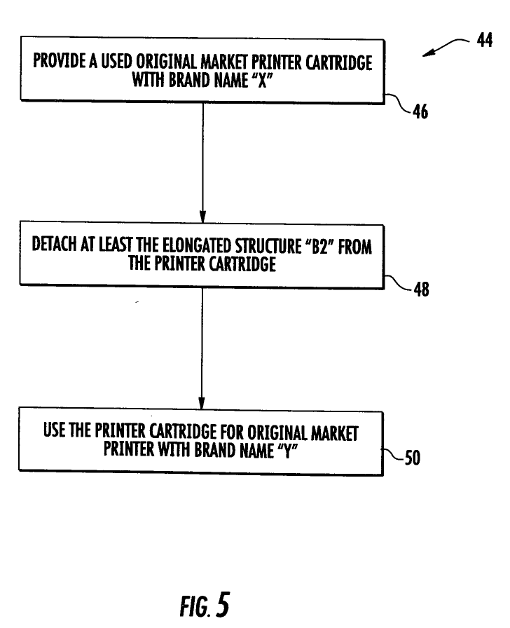

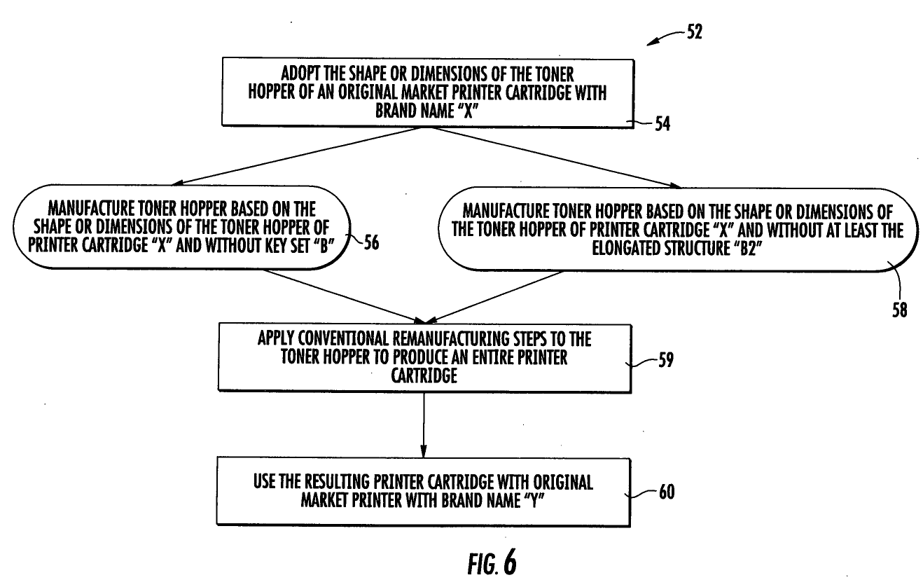

A second embodiment 52 of a conversion method of the present invention is shown in FIG. 6 wherein, at step 54, the shape or dimensions of the toner hopper of an original market printer cartridge of a particular brand is preferably adopted such that the resulting toner hopper or printer cartridge can properly fit into the respective printer cartridge housing of the intended printer for which the toner resulting toner hopper or printer cartridge will be used. At step 56, a toner hopper based on the shape or dimensions of the toner hopper of the original market printer cartridge is preferably manufactured without key set “B.” Alternatively, at step 58, a toner hopper based on the shape or dimensions of the toner hopper of the original market printer cartridge is preferably manufactured without at least the elongated structure “B2.” At step 59, conventional remanufacturing steps may be applied to the toner hopper to produce an entire printer cartridge. At step 60, the resulting printer cartridge may be used with an original market printer of a different brand. It is noted that various embodiments of conversion methods of the present invention may be combined with conventional remanufacturing steps, such as cleaning the used printer cartridge, using used original market parts, and refilling the toner supply thereby resulting to new printer cartridge remanufacturing methods.

Referring now to FIG. 7, a third embodiment 62 of a conversion method is shown wherein at step 64, the shape or dimensions of an original market printer cartridge of a particular brand is preferably adopted. At step 66, a printer cartridge based on the shape or dimensions of the original market printer cartridge is preferably manufactured without key set “B.” Alternatively, at step 68, a printer cartridge based on the shape or dimensions of the original market printer cartridge is preferably manufactured without at least the elongated structure “B2.” At step 70, the newly manufactured printer cartridge may be used with an original market printer of a different brand. Thus, it can be appreciated that certain conversion methods of the present invention increases the compatibility of printer cartridges in that original market printer cartridges or original market printer cartridge designs that used to be for exclusive use with certain printers may now be compatible for use with a wide variety of printers.

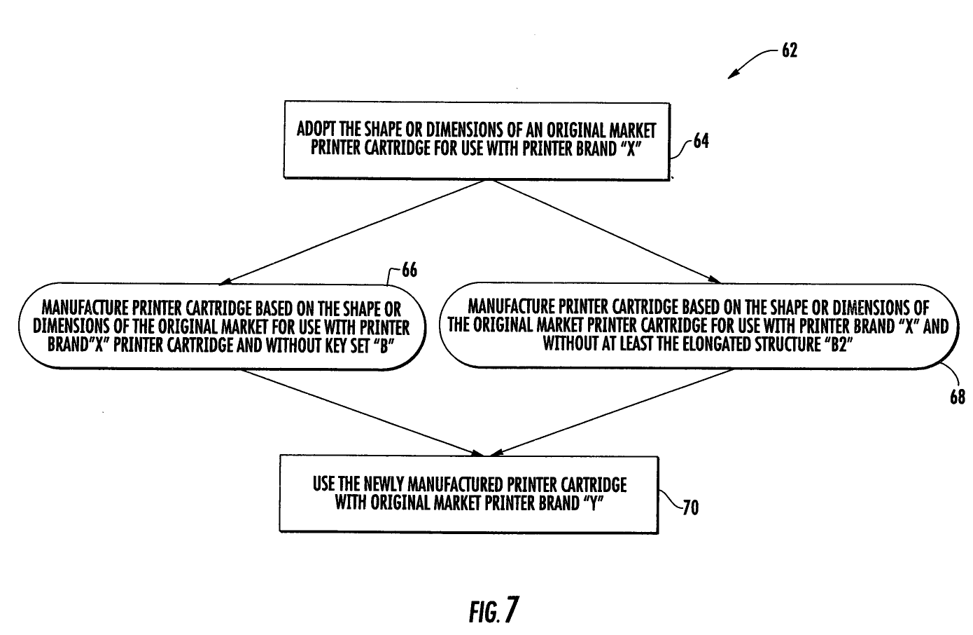

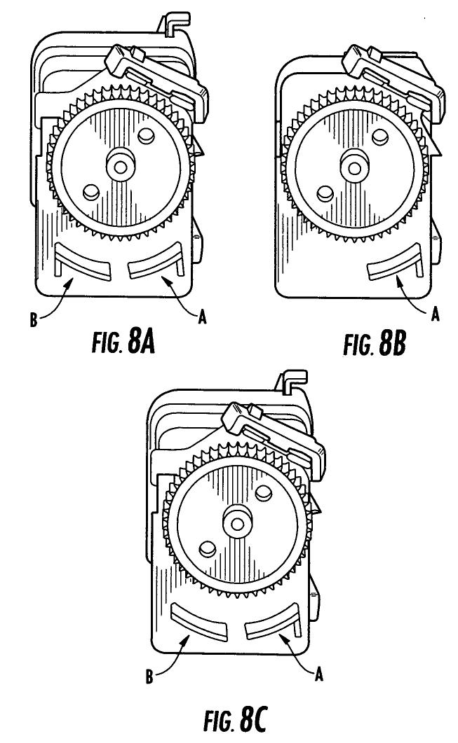

Referring now to FIG. 8a, a printer cartridge resulting from the methods shown in flowcharts 44, 52, or 62 is shown wherein the printer cartridge has no elongated structure “B2.” A toner hopper resulting from the methods shown in flowcharts 44, 52, or 62 is shown (FIG. 8b) wherein the printer cartridge has no key set “B.” Yet another printer cartridge resulting from the methods shown in flowcharts 44, 52, or 62 is shown (FIG. 8c) wherein the printer cartridge has no elongated structures “B2” and “B3.” It can be realized that the printer cartridge or toner hopper resulting from the methods of the present invention have key sets that can fit within key receivers or have no key sets that cannot fit within key receivers of printer cartridge housings of various original market printer brands.

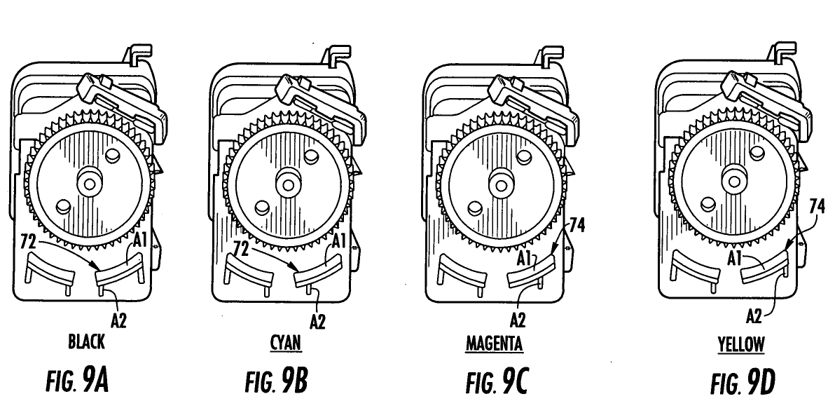

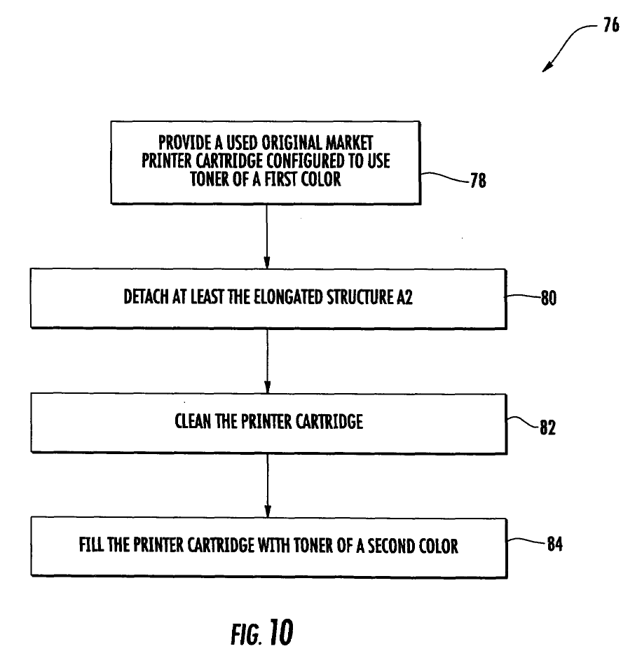

The applicants have further discovered that the positions of elongated structure “A2” on the toner hoppers 22 and their respective tab receivers “RA2” on the printer cartridge housing may vary depending on the color of toner intended for the printer cartridge. Printer cartridge intended for using black toner (FIG. 9a) may have an elongated structure “A2” positioned at the first tip 72 of the arched structure “A1.” Printer cartridge intended for using cyan toner (FIG. 9b) may have an elongated structure “A2” positioned substantially in between the first tip 72 and the center of the arched structure “A1.” Printer cartridge intended for using magenta toner (FIG. 9c) may have an elongated structure “A2” positioned substantially in between the second tip 74 and the center of the arched structure “A1.” Printer cartridge intended for using yellow toner (FIG. 9d) may have an elongated structure “A2” positioned at the second tip 74 of the arched structure “A1.” Based on this discovery, applicants have devised additional methods for increasing printer compatibility of printer cartridges.

Referring now to FIG. 10, a fourth embodiment 76 of a conversion method of the present invention includes the following steps. At step 78, a used original market printer cartridge configured to be supplied with toner of a particular color is preferably provided. At step 80, at least the elongated structure “A2” is preferably detached from the printer cartridge. The elongate structure “A2” may be detached from the printer cartridge using methods known in the art, such as cutting, breaking, destroying, or ruining the elongated structure A2. Conventional tools known in the art may be used to detach the elongated structure A2, such as a utility knife or a rotary cutting tool. Next, the printer cartridge may be cleaned to remove old toner (step 82). The printer cartridge may then be filled with toner of a different color (step 84) and positioned in its appropriate printer housing in the printer. It can now be realized that the resulting printer cartridge is no longer limited to the toner color that it can accommodate. For instance, if the used printer cartridge was intended to be filled with black toner and positioned in a printer housing for cartridge with black toner, the printer cartridge may be converted using the methods of the present so that it can be filled with cyan and positioned in a printer housing for cyan cartridge.

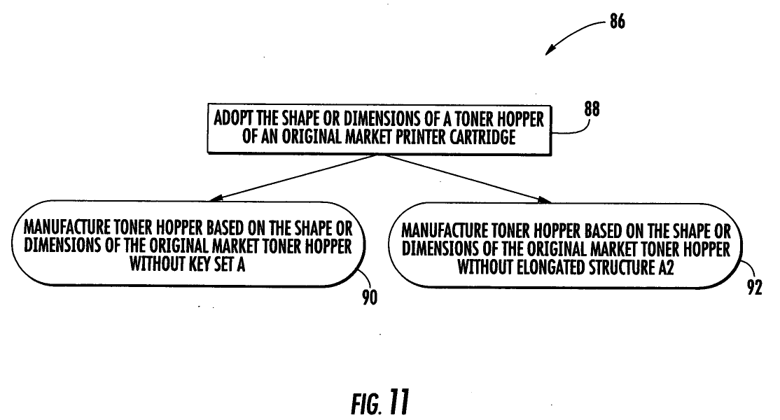

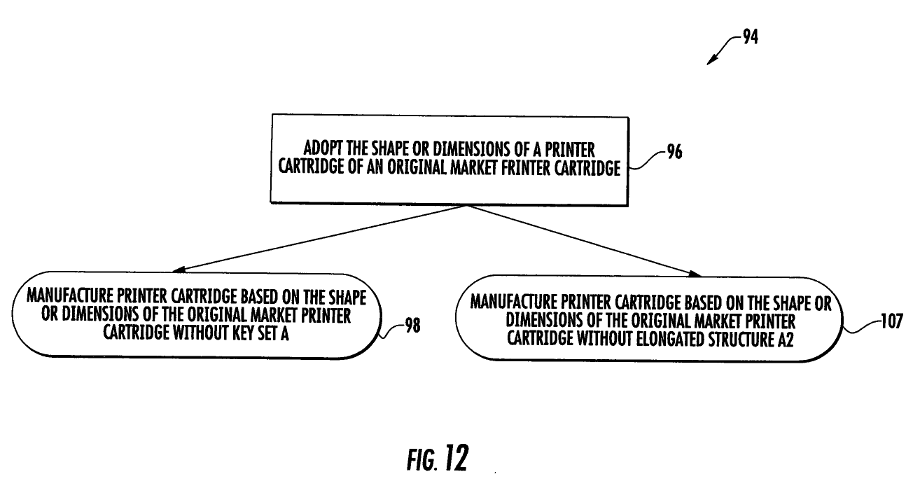

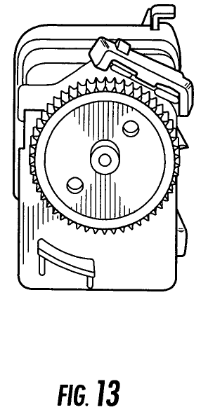

A fifth embodiment 86 of a conversion method of the present invention is shown in FIG. 11 wherein, at step 88, the shape or dimensions of the toner hopper of an original market printer cartridge is preferably adopted. At step 90, a toner hopper based on the shape or dimensions of the toner hopper of the original market printer cartridge is preferably manufactured without key set “A.” Alternatively, at step 92, a toner hopper based on the shape or dimensions of the toner hopper of the original market printer cartridge is preferably manufactured without at least the elongated structure “A2.” Conventional remanufacturing steps may be applied to the newly manufactured toner hopper from embodiment 86 to produce a compliant printer cartridge that can be refilled with either magenta, yellow, black, or cyan toner. After the entire printer cartridge is remanufactured, the printer cartridge may be placed in its appropriate housing in the printer.

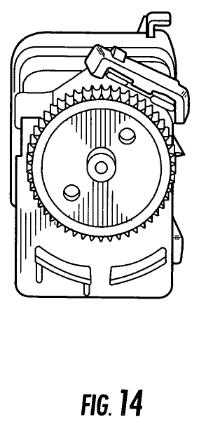

Referring now to FIG. 12, a sixth embodiment 94 of a conversion method is shown wherein at step 96, the shape or dimensions of an original market printer cartridge is preferably adopted. At step 98, a printer cartridge based on the shape or dimensions of the original market printer cartridge is preferably manufactured without key set “A” (FIG. 13). Alternatively, at step 100, a printer cartridge based on the shape or dimensions of the original market printer cartridge is preferably manufactured without at least the elongated structure “A2” (FIG. 14). The newly manufactured printer cartridge may be filled with either magenta, yellow, black or cyan toner. The printer cartridge may then be placed in its appropriate housing in the printer. Thus, it can be appreciated that certain conversion methods of the present invention increases the compatibility of printer cartridges in that printer cartridges that previously required a certain color of toner may now be filled with other toner colors.

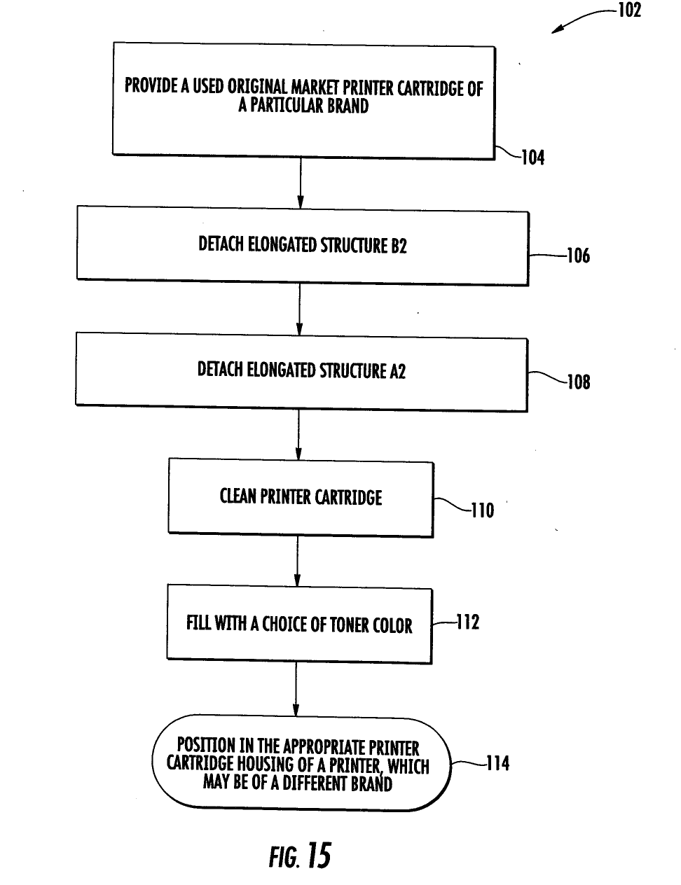

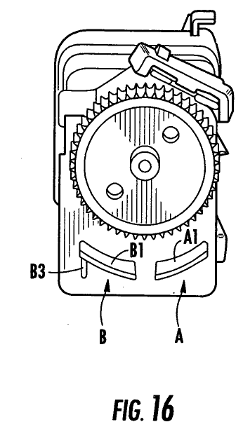

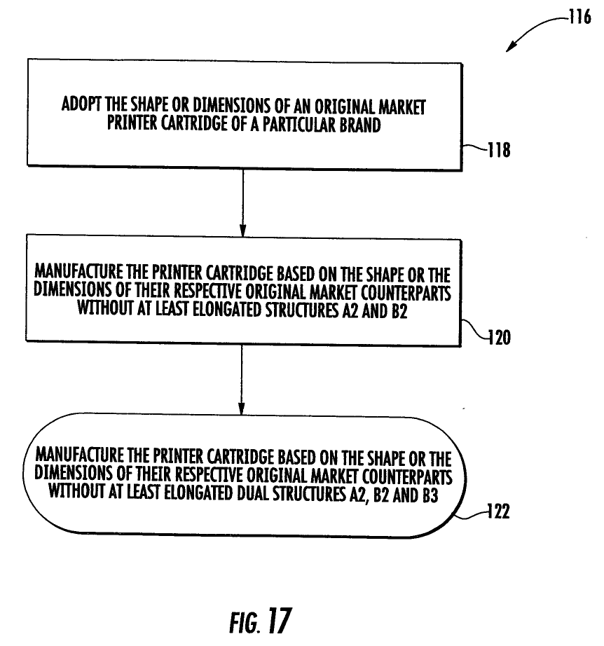

Referring now to FIG. 15, a seventh embodiment 102 of a conversion method is shown wherein the printer cartridge is converted such that it can be used with multiple printer brands and it can be filled with a choice of toner colors. At step 104, a used original market printer cartridge of a particular brand may be provided. At step 106, the elongated structure “B2” of the printer cartridge may then be detached. At step 108, the elongated structure “A2” may also be detached (FIG. 16). Referring back to FIG. 15, the resulting printer cartridge may then be cleaned (step 110), filled with a choice of toner color, such as magenta, cyan, yellow, or black (step 112), and positioned within the appropriate printer cartridge housing of a printer, which may be of a different brand (step 114).

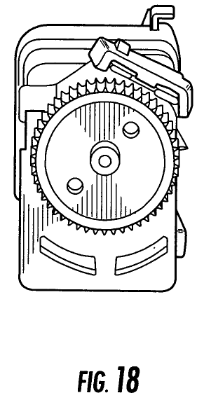

With reference now to FIG. 17, an eighth embodiment 116 of a conversion is shown wherein the printer cartridge is also converted such that it can be used with multiple printer brands and it can be filled with a choice of toner colors. At step 118, the shape or dimensions of the original market printer cartridge of a particular brand is preferably adopted. At step 120, the printer cartridge is preferably manufactured based on the shape or dimensions of their original market counterparts without elongated structures “A2” and “B2” (FIG. 16). Alternatively, at step 122, a toner hopper or printer cartridge based on the shape or dimensions of the original market printer cartridge is preferably manufactured without at least the elongated structures “A2”, “B2”, and “B3” (FIG. 18). The newly manufactured printer cartridge may be filled with magenta, yellow, black or cyan toner. The printer cartridge may then be placed in its appropriate housing in a printer that may be of a different brand. In another embodiment of a conversion method, steps 118, 120, and 122 may be executed to a toner hopper instead of a printer cartridge. Conventional remanufacturing steps may then be performed on the toner hopper to create an entire compliant printer cartridge.

It can now be realized that certain embodiments of the present invention provide conversion methods that reduce the number of different kinds of products distributors may need to have inventories. With certain embodiments of the present invention, distributors may only need to carry one type of printer cartridge plastic in their inventory. Certain embodiments of the present invention provide methods for increasing the availability of printer cartridges that may be in short supply. Remanufacturers of printer cartridges may be able to save money from the cost of empties and increase their profitability by using various methods of the present invention.

Although the description above contains many specifications, these should not be construed as limiting the scope of the invention but as merely providing illustrations of some of the presently preferred embodiments of this invention. For example, various techniques and tools may be used to detach key sets or key components from the printer cartridges. The invention is capable of other embodiments and of being practiced and carried out in various ways. The invention is not limited in its application to the details of the construction and to the arrangement of the components set forth in the above description or as illustrated in the drawings.

What is claimed is:

1. A method of making an aftermarket printer cartridge, the aftermarket printer cartridge substantially resembling an original market printer cartridge, the original market printer cartridge comprising a key set attached to a toner hopper, the key set comprising an arched structure and at least one elongated structure attached to the arched structure, the method comprising providing an aftermarket toner hopper resembling the toner hopper of the original market printer cartridge, the aftermarket toner hopper missing at least one elongated structure of the key set.

2. The method of claim 1, wherein the original market printer cartridge is configured to be used with a printer of a particular brand, the aftermarket printer cartridge being able to work with a printer of a brand that is different from the printer for which the original market printer cartridge was originally designed.

3. The method of claim 1, wherein the original market printer cartridge is to be filled with a toner of a particular color, the aftermarket printer cartridge being able to work with a toner color different from the toner color for which the original market printer cartridge was originally designed.

4. The method of claim 1, further comprising molding plastic for the aftermarket toner hopper without the at least one elongated structure of the key set.

5. The method claim 1, further comprising detaching the elongated structure from the aftermarket toner hopper.

6. The method claim 1, further comprising cutting off the elongated structure from the aftermarket toner hopper.

7. The method of claim 1, wherein the aftermarket toner hopper provided is a toner hopper from a used original market printer cartridge.

8. The method of claim 7, further comprising:
a. replacing at least one worn part of the used original market printer cartridge; and
b. filling the used original market printer cartridge with toner.

9. The method of claim 1, wherein the first key set comprises a plurality of elongated structures attached to the arched structure, the aftermarket toner hopper missing the plurality of elongated structures.

10. The method of claim 1, wherein the original market printer cartridge is configured to be used with a toner of a particular color, the original market printer cartridge comprising a second key set, the second key set comprising an arched structure and at least one elongated structure attached to the arched structure, the aftermarket toner hopper missing at least one elongated structure of the second key set, the aftermarket printer cartridge being able to work with toner of a color that is different from the toner color the original market printer cartridge is configured to accommodate.

11. An aftermarket printer cartridge configured to be used with an original market printer, the original market printer comprising a plurality of printer cartridge housing for housing a plurality of printer cartridges, each printer cartridge housing comprising a distinct cartridge screening wall, each distinct cartridge screening wall defining a distinct set of recesses for receiving various structures of a printer cartridge key set, the aftermarket printer cartridge comprising:
a. a toner hopper resembling an original market toner hopper;
b. a first printer cartridge key set attached to one end of the toner hopper, the first printer cartridge key set comprising a first arched structure; and
c. a second printer cartridge key set attached to the same end of the toner hopper, the second printer cartridge key set being positioned proximate to the first printer cartridge key set, the second printer cartridge key set comprising a second arched structure, wherein the first and second arched structures of the toner hopper are configured to insert through their respective recesses on the cartridge screening wall, the toner hopper being usable with multiple printer cartridge housings having distinct cartridge screening walls.

12. The printer cartridge of claim 11, wherein the original market toner hopper comprises a first elongated structure attached to the first arched structure and a second elongated structure attached to the second arched structure, the aftermarket printer cartridge missing the first and second elongated structure.

13. The printer cartridge of claim 11, wherein the original market toner hopper comprises an elongated structure attached to the first arched structure, the aftermarket printer cartridge missing the elongated structure.

14. The printer cartridge of claim 11, wherein the original market toner hopper comprises an elongated structure attached to the second arched structure, the aftermarket printer cartridge missing the elongated structure.

15. The printer cartridge of claim 11, further comprising toner of a particular color, the toner color being different from the toner color the original market cartridge is configured to accommodate.

16. A method of manufacturing an aftermarket printer cartridge toner hopper, the method comprising the steps of:
a. adopting the overall shape of an original market printer cartridge toner hopper for an aftermarket printer cartridge toner hopper design;
b. eliminating in the aftermarket printer cartridge toner hopper design at least one keying mechanism feature of the original market printer cartridge toner hopper; and
c. molding plastic for an aftermarket printer cartridge toner hopper based on the aftermarket printer cartridge toner hopper design.

17. The method of claim 16, wherein the at least one keying mechanism feature is adjacent to an agitator gear of the toner hopper.

18. The method of claim 16, wherein the original market printer cartridge toner hopper comprises a plurality of keying mechanism sets, the method further comprising eliminating at least one keying mechanism set out of the plurality of keying mechanism sets.
